(19) United States
(12) Patent Application Publication
(10) Pub. No.: US 2009/0159257 A1
(43) Pub. Date: Jun. 25, 2009

(54) METHOD AND SYSTEM FOR REGULATING A CONTINUOUS CRYSTALLIZATION PROCESS

(75) Inventors: Thomas Marolt, Duisburg (DE); Dirk Bergmann, Tonisvorst (DE); Abdelaziz Toumi, Dusseldorf (DE); Arne Braun, Leverkusen (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/341,270

(22) Filed: Dec. 22, 2008

(30) Foreign Application Priority Data
Dec. 20, 2007 (DE) 102007062422.2

(51) Int. Cl. G05D 23/19; G05D 23/00

(52) U.S. Cl. 165/270; 165/287

(57) ABSTRACT

A process and a system for regulating a continuous crystallization process which can be used especially for preparation of bisphenol A comprises a heat exchanger connected in a circuit to a crystallization apparatus. A heat exchange performance of the heat exchanger to cool an exit stream of the crystallization apparatus is established as a function of a feed stream supplied, in order to deliver by regulation an exit temperature of the exit stream. The heat exchange performance is calculated, and the calculated heat exchange performance is established in the heat exchanger with a time delay. The time delay prevents large temperature differences in the heat exchanger, so as to prevent fouling in the heat exchanger. With improved regulation quality, this leads to fewer production shutdowns and hence to improved productivity.

### BACKGROUND OF THE INVENTION

1. Field of the Invention

The field of the present invention relates to a method and to a system for regulation of a continuous crystallization process, which can be used in the preparation of chemical products, for example bisphenol A (BPA).

2. Background

For the preparation of crystalline products, it is known that a crystallization apparatus in which the crystals desired as the product are precipitated from a solution can be connected in a circuit to a heat exchanger. In the case of this connection known as the forced-circulation principle, a suspension is circulated through the heat exchanger and crystallization apparatus with the aid of a pump. The heat exchanger can remove the heat required to supercool the suspension and the heat of crystallization released in the crystallization. In continuous operation, the heat-removed by the heat exchanger can be used to keep the temperature in the crystallization apparatus constant. Especially for downstream processes in which the crystalline product is required, it is important that an exit temperature of an exit stream leaving the crystallization apparatus is kept constant, since a product stream which supplies the crystalline product to a subsequent treatment is branched off from the exit stream. The exit temperature of the exit stream is also influenced by a feed stream supplied to the circulation stream.

Since a change in the feed stream supplied is normally abrupt, considerable disruption is caused in the crystallization process, which can be eliminated only after an unsatisfactorily long time. In order to minimize this malfunction, it is known that the heat exchange performance of the heat exchanger can be adjusted manually on the basis of experience values. However, this leads to the effect that considerable temperature differences between a cooling medium and the circulation stream to be cooled arise in the heat exchanger, which in turn lead to fouling of the heat exchanger, by virtue, for example, of crystallized products being deposited on the heat exchanger walls. Since this fouling brings about a decrease in the heat transfer coefficient k and an increase in the pressure drop on the suspension side and, according to the pump characteristic of the pump used, a decrease in the flow rates and layer formation up to and including blockage of flow channels on the suspension side, repeated regeneration of the heat exchanger by dissolving or melting the fouling layers is required. The fouling necessitates regeneration of the heat exchanger within comparatively short time intervals, as a result of which the crystallization process is interrupted for the period of regeneration of the heat exchanger. This leads to production shutdowns and low productivity. Moreover, the fouling reduces the achievable heat exchange performance, which complicates the control of the crystallization process. More particularly, such changes cannot be taken into account in the application of experience values, and so only insufficient regulation quality for a crystallization process can be achieved.

### SUMMARY OF THE INVENTION

In the process according to the invention for regulating a continuous crystallization process, a crystallization apparatus is first connected to a heat exchanger in a circuit, and a continuous circulation stream is established, for example with a pump. This continuous crystallization process is suitable especially for the cooling crystallization of bisphenol A-phenol adduct in the preparation of bisphenol A. In the continuous cooling crystallization, the yield of product to be crystallized is dependent on the crystallization temperature. At lower temperatures, crystallization performance and yield rise; the concentration in the mother liquor falls accordingly. As well as the yield, there are further criteria for selection of the crystallization temperature, for example a temperature-dependent incorporation of impurities into the product crystals, which has an effect on the product quality. For these reasons, in the continuous cooling crystallization, the crystallization temperature of the crystallization apparatus and/or an exit temperature of the exit stream from the crystallization apparatus are regulated. For this purpose, a cooling performance which essentially depends on the amount of the feed stream supplied is established in the heat exchanger.

The currently required heat exchange performance is determined by calculation, the calculated heat exchange performance being established in the heat exchanger with a time delay.

The time delay can be achieved with the aid of various measures. For example, the control system may comprise a dead time element, such that the time delay comprises a dead time. Additionally or alternatively, the heat exchange performance can be varied essentially integrally in the event of an abrupt change in the feed stream, such that the heat exchange performance changes essentially in the form of a ramp. Additionally or alternatively, proportional transfer behaviour with delay can be provided, which especially has essentially PT₁ behaviour (1st order delay element with time delay).

The system for regulating a continuous crystallization process is suitable especially for performing the above-described process and/or can be configured and developed as explained for the above-described process. The system can be used especially to prepare bisphenol A (BPA). The system comprises a crystallization apparatus which is connected in a circuit to a heat exchanger for cooling an exit stream of the crystallization apparatus. To deliver an exit temperature of the exit stream and/or a crystallization temperature of the crystallization apparatus by regulation, a heat exchange performance of the heat exchanger can be established with the aid of an establishment unit as a function of a feed stream supplied. At least one calculator unit is provided, which determines the currently required heat exchange performance by calculation, and the calculated heat exchange performance is passed on to the establishment unit in such a way that the calculated heat exchange performance can be established in the heat exchanger with a time delay.

For the time delay, a first regulation circuit in particular is provided to deliver by regulation a heat exchanger target exit temperature as a function of the exit temperature of the crystallization apparatus. The first regulation circuit may especially comprise at least one PID regulator. In addition, a second regulation circuit can be provided to deliver by regulation a correction term for the time delay of the heat exchanger target exit temperature delivered by the first regulation circuit as a function of the feed stream. The second regulation circuit comprises, in particular, a PT₁ regulator. More preferably, the first regulation circuit comprises a first regulator, in particular PID regulator, for delivery of the heat exchanger target exit temperature by regulation. In addition, in the first regulation circuit, a second regulator, particularly PID regulator, can be provided for delivery of a cooling temperature and/or cooling rate of a cooling medium for the heat exchanger by regulation. More particularly, the first regulator reacts more slowly than the second regulator. By action of the first regulator reacting relatively slowly, excessive temperature differences in the heat exchanger are prevented, which can otherwise lead to fouling. Since the cooling medium, however, must not comprise any crystallizable substances, the temperature of the cooling medium can quite possibly be regulated by providing large temperature differences. The faster second regulator thus leads to the required temperature and/or cooling rate of the cooling medium being provided very rapidly without any risk of fouling at the same time.

The second regulation circuit preferably comprises a third regulator; especially PT₁ regulator, which especially has a time constant as the regulation parameter. The regulation parameters, especially a T1 element, can be adjustable as a function of the fouling state of the heat exchanger and/or as a function of a heat transfer coefficient k of the heat exchanger. This enables the fouling state of the heat exchanger, which changes over the operating time, to be taken into account in the regulation.

More preferably, The system may also comprise a temperature measuring instrument with whose aid a heat exchanger exit temperature can be measured. With the aid of the calculator unit, the measured heat exchanger exit temperature can be compared with a heat exchanger exit temperature determined by calculation by the calculator unit. This comparison allows the fouling state of the heat exchanger or the heat transfer coefficient k of the heat exchanger to be determined.

Accordingly, an improved method and system for regulating a continuous crystallization process are disclosed. Advantages of the improvements will appear from the drawings and the description of the preferred embodiment.

### BRIEF DESCRIPTION OF THE DRAWINGS

In the drawings, wherein like reference numerals refer to similar components:

FIG. 1 illustrates a schematic block connection diagram of a system for regulating a continuous crystallization process; and

FIG. 2 illustrates a schematic regulation circuit diagram used for regulating a continuous crystallization process.

### DETAILED DESCRIPTION OF THE PREFERRED EMBODIMENTS

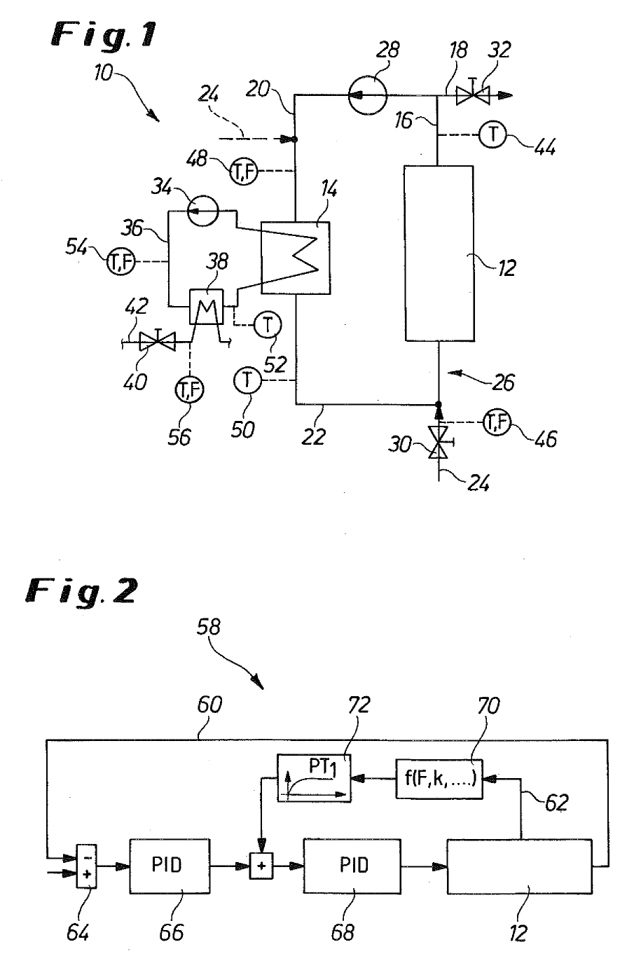

The system 10 shown in FIG. 1 comprises a crystallization apparatus 12 which is connected in a circuit to a heat exchanger 14. An exit stream 16 leaves the crystallization apparatus 12 and branches into a product stream 18 and a heat exchanger stream 20. The heat exchanger stream 20 opens into the heat exchanger 14. From the heat exchanger 14, a heat exchanger exit stream 22 flows to the crystallization apparatus 12. In the working example shown, a feed stream 24 is supplied to the heat exchanger exit stream 22. However, the feed stream 24 can also be supplied to the heat exchanger stream 20. The exit stream 16, the heat exchanger stream 20 and the heat exchanger exit stream 22 form a circuit 26 in which a pump 28 is arranged in order to convey the suspension present in the circuit 26.

The amount of the feed stream 24, i.e., more particularly, the mass flow, can be established by a first valve 30 disposed in the feed stream 24. The product stream 18 may, for example, instead of the first valve 30, comprise a second valve 32 in order to establish the amount of product withdrawn from the circuit 26. Since the plant is especially completely filled, exactly as much fluid is conveyed out of the circuit 26 via the product stream 18 in continuous operation as is supplied to the circuit 26 via the feed stream 24.

The medium supplied via the circuit 26 comprising the heat exchanger 14 is cooled in the heat exchanger 14 with the aid of a cooling medium which is conveyed in circulation in a cooling circuit 36 with the aid of a cooling pump 34. In the cooling circuit 36 is disposed a cooling heat exchanger 38 with whose aid the cooling medium can be regulated to a defined temperature. A third valve 40 can be used to convey an external coolant for cooling the cooling medium through the cooling heat exchanger 38 via an external cooling line 42.

With the aid of a first measuring instrument 44, the exit temperature of the exit stream 16, which is to be regulated, is measured. With the aid of a second measuring instrument 46, the temperature and the mass flow of the feed stream 24 are measured, in order to be able to calculate the parameters for the heat exchanger 14 with the aid of this information. To improve the quality of the regulation, the temperature and the mass flow of the heat exchanger stream 20 can be measured at the inlet of the heat exchanger 14 with the aid of a third measuring instrument 48. To be able to check the success of the regulation, the temperature of the heat exchanger exit stream 22 can be measured at the outlet of the heat exchanger 14 with the aid of a fourth measuring instrument 50. To regulate the exit temperature of the exit stream 16, in particular, the temperature of the cooling medium of the cooling circuit 36 entering the heat exchanger 14 is established, this temperature being measurable with the aid of a fifth measuring instrument 52. Since this temperature is to be established by means of the cooling heat exchanger 38, one possibility is to measure the temperature and the mass flow of the cooling medium in the cooling circuit 36 by means of a sixth measuring instrument 54 before the cooling medium enters the cooling heat exchanger 38. With the aid of a measuring instrument 56, the temperature and the mass flow of the external coolant entering the heat exchanger 38 can be measured to establish the temperature and the cooling medium of the cooling circuit 36. With the aid of the information measured, the third valve 40 of the external coolant stream 42 can be set. In addition, the performance of the cooling pump 34 can be varied as a function of the parameters measured.

The regulation circuit 58 shown in FIG. 2 has a cascaded configuration and comprises an outer first regulation circuit 60 and an inner second regulation circuit 62. The first regulation circuit 60 comprises a comparison unit 64 in which the exit temperature of the exit stream 16 from the crystallization apparatus 12 is compared with a target value. On the basis of this comparison, a target value for the heat exchanger exit temperature of the heat exchanger exit stream 22 is determined with the aid of a first PID regulator 66 which has been set to be slow. To achieve this heat exchanger target exit temperature, the temperature of the cooling medium of the cooling circuit 36 entering the heat exchanger 14 is regulated with the aid of a second PID regulator 68 which has been set to be fast. The regulation of the temperature of the cooling medium regulates the heat exchanger exit temperature, which in turn influences the crystallization apparatus 12, such that the exit temperature of the exit stream 16 leaving the crystallization apparatus 12 can be regulated.

To prevent fouling in the heat exchanger 14, a calculator unit 70 which calculates a heat exchange performance to be established in the heat exchanger 14 as a function of the mass flow of the feed stream 24 and/or of the mass flow of the exit stream 16 is provided in the second regulation circuit 62. In this case, the fouling state of the heat exchanger 14 in particular can be taken into account by, for example, determining the heat transfer coefficient k of the heat exchanger 14. In addition, further information which is available especially as a result of the measuring instruments 44, 46, 48, 50, 52, 56 which are present in any case can be processed. The heat exchange performance calculated for the heat exchanger 14 is passed on with a time delay via a PT₁ regulator 72. For this purpose, a correction term is determined, which corrects the heat exchanger target exit temperature given by the first PID regulator 66. This prevents too great a variation in the heat exchanger target exit temperature.

By virtue of the heat exchange performance being determined by calculation as a function of the feed stream, it is possible to determine the heat exchange performance required at a very early stage, and it is here especially possible to take account of the inertia of the crystallization process. More particularly, it is possible to take account of an average residence time in the crystallization apparatus which, in industrial plants, may, for example, be within a range from 30 minutes to 10 hours. This enables, by way of a feed-forward control system, to act in anticipation of the expected change with the heat exchange performance. However, the heat exchange performance calculated is not established immediately in the heat exchanger, but rather with a time delay. The reaction is thus deliberately chosen to be slower than would be technically possible. The time delay prevents sudden temperature changes in the heat exchanger, so as to prevent or at least reduce considerable temperature differences between the cooling medium of the heat exchanger and the circulation stream. This reduces oversaturation peaks in the heat exchanger which occur, for example, immediately at a tube wall due to the local supercooling of the suspension, and inducing solids formation or crystallization on the heat transfer surfaces. This allows fouling of the heat exchanger as a result of deposition of solids on the heat transfer surfaces to be significantly slowed down. In the case of slowed fouling, the regeneration intervals for the heat exchanger can be increased, which reduces production shutdowns and improves the productivity. Moreover, the feed-forward control system based on mathematical calculations, for example energy balances, can react significantly more precisely and rapidly to disruption in the crystallization process than would be possible with manual interventions, and so the regulation quality is improved. Especially in the case of use of energy balances in the calculation of the heat exchange performance, explicit solutions are possible mathematically, and so possibly calculation-intensive numerical iteration processes can be avoided. Studies have shown that such a feed-forward control system with a time delay, as compared with the same feed-forward control system without time delay, results in only insignificant differences in the exit temperature of the exit stream. These slight variations in the exit temperature can, however, normally be eliminated by regulation without any great problems in the downstream processes, and so there is not even the risk of a slight loss in the yield of the end product.

The time delay may also take greater account of the feed stream supplied compared to the exit temperature. In this context, it is possible to take account of the fact that certain system-related temperature variations which always take place in the course of continuous operation of the crystallization process do not necessarily require an intervention, since these temperature variations in the crystallization apparatus can correct themselves. In addition, it is possible to take account of the fact that a change in the feed stream normally occurs suddenly and undergoes a significant change, since, for example, the desired product rate has been changed manually. By virtue of such a change being subject to a relatively high time delay, too strong a reaction of the heat exchanger can be prevented, such that the risk of fouling in the heat exchanger is reduced and a long operating time of the heat exchanger can be ensured.

The time delay may be achieved by means of cascaded regulation circuits. More particularly, a heat exchanger target exit temperature for the time delay can be delivered by regulation as a function of the exit temperature of the crystallization apparatus with the aid of a first regulation circuit. A correction term for the time delay of the heat exchanger target exit temperature delivered by the first regulation circuit can be delivered by regulation as a function of the feed stream with the aid of a second regulation circuit. As a result, with the aid of the first regulation circuit, in continuous operation, the temperature variations in the exit temperature which typically occur can be balanced out. Since there is essentially no variation in the feed stream in this mode of operation, the second regulation circuit has essentially no influence. If, however, the continuous operation is disrupted by virtue of the amount of the feed stream supplied being increased significantly or reduced significantly, the second regulation circuit prevents the first regulation circuit optimized for continuous operation from changing the heat exchange performance of the heat exchanger too greatly. The time-delayed correction term allows the heat exchanger target exit temperature to be adjusted such that the probability of fouling in the heat exchanger is reduced.

The heat exchange performance which is required at the present time of operation or is required at a defined later time of operation can be calculated with the aid of energy balances. For this purpose, especially the mass flow and the temperature of a heat exchanger stream coming from the crystallization apparatus and entering the heat exchanger are taken into account. The mass flow and the temperature of the heat exchanger stream can especially be calculated. Since the exit temperature of the exit stream is regulated by measuring the actual exit temperature of the exit stream, experience values or the calculation of performance losses can be used to determine what temperature the heat exchanger stream will have on entry into the heat exchanger. In addition, the mass flow of the feed stream supplied and the mass flow of the product stream removed are typically known, and so the mass flow of the heat exchanger stream entering the heat exchanger can be calculated. In addition, it is possible to estimate the behaviour of the crystallization apparatus empirically or to simulate it, such that it can be sufficient merely to know the temperature and the mass flow of the feed stream supplied in order to calculate the mass flow and the temperature of the heat exchanger stream entering the heat exchanger. It is thus possible to calculate the heat exchanger target exit temperature which is required for regulation of the exit temperature and, with knowledge of the mass flow of the heat exchanger stream entering the heat exchanger, to very exactly determine the heat exchange performance required.

The calculation of the heat exchange performance preferably takes account of the fouling state of the heat exchanger. This can be done especially by taking account of a heat transfer coefficient k of the heat exchanger. The heat transfer coefficient k can be determined especially by comparing a theoretically calculated heat exchanger exit temperature with an actually measured heat exchanger exit temperature. On the basis of this comparison, the heat transfer coefficient k which is required in order that the calculated heat exchanger exit temperature corresponds to the measured heat exchanger exit temperature can be determined. In particular, it is thus also possible to determine and be able to indicate the fouling state of the heat exchanger with reference to a single parameter proportional to the fouling state. It is thus possible to undertake maintenance and regeneration of the heat exchanger only when the heat transfer coefficient k is outside a predefined range of values. Definition of fixed maintenance intervals is not required. Instead, maintenance is performed only when it is actually required. More particularly, the plot of the heat transfer coefficient k against time can be extrapolated, such that the approximate time for the next maintenance of the heat exchanger can already be estimated in advance.

To establish the heat exchange performance of the heat exchanger, a cooling temperature and/or cooling rate of a cooling medium for the heat exchanger can be delivered by regulation. For this purpose, for example, two or more cooling sources at different cooling levels can be switched on and/or off, in order to change the cooling temperature and/or cooling rate of the cooling medium. In addition, the power of a cooling pump for the cooling medium can be varied in order to change the throughput of the cooling medium. The cooling temperature and/or the cooling rate of the cooling medium may be regulated with the aid of a third regulation circuit which regulates the cooling temperature and/or the cooling rate of the cooling medium as a function of the time-delayed heat exchange performance. This enables particularly anticipatory regulation, since, for example, the information of a changing feed stream can be utilized actually for the cooling medium for the heat exchanger. This is especially helpful if additional apparatus is required to provide sufficient coldness, which first has to be switched on or off and a lead time is required for this purpose.

The time delay in the heat exchange performance to be established in the heat exchanger prevents great temperature differences within the heat exchanger, which prevents or at least reduces fouling of the heat exchanger. Since maintenance and regeneration of the heat exchanger are required less often as a result, production shutdowns are avoided and productivity is increased. In addition, the calculator unit connected to the establishment unit improves the regulation quality of the crystallization process, since manual control interventions can be avoided.

Thus, a method and a system for regulating a continuous crystallization process are disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A method of regulating a continuous crystallization process, especially for preparing bisphenol A, the method comprising:
connecting a heat exchanger in a circuit to a crystallization apparatus;
establishing a heat exchange performance of the heat exchanger, to cool an exit stream of the crystallization apparatus, the heat exchange performance being a function of a feed stream supplied into the circuit and being used to deliver by regulation at least one of a crystallization temperature of the crystallization apparatus and an exit temperature of the exit stream;
calculating the heat exchange performance; and
establishing, with a time delay, the calculated heat exchange performance in the heat exchanger.

2. The process according to claim 1, wherein the time delay comprises at least one of a dead time, an essentially integral variation in the heat exchange performance to be established, and a proportional transfer behaviour with a delay in the form of essentially PT₁ behaviour.

3. The process according to claim 1, wherein the time delay takes greater account of the feed stream supplied compared to the exit temperature.

4. The process according to claim 1, further comprising
delivering a heat exchanger target exit temperature for the time delay by regulation as a function of the exit temperature of the crystallization apparatus with the aid of a first regulation circuit, and
delivering a correction term for the time delay of the heat exchanger target exit temperature delivered by the first regulation circuit by regulation as a function of the feed stream with the aid of a second regulation circuit.

5. The process according to claim 1, wherein calculating the heat exchange performance includes calculating the heat exchange performance with the aid of energy balances, and calculating the mass flow and the temperature of a heat exchanger stream coming from the crystallization apparatus and entering the heat exchanger.

6. The process according to claim 1, wherein calculating the heat exchange performance includes taking into account a fouling state of the heat exchanger.

7. The process according to claim 6, wherein a heat transfer coefficient k of the heat exchanger is taken into account for the fouling state.

8. The process according to claim 7, further comprising determining the heat transfer coefficient k by a comparison of a calculated heat exchanger exit temperature and a measured heat exchanger exit temperature.

9. The process according to claim 1, wherein the heat exchange performance is established by delivering by regulation at least one of a cooling temperature and cooling rate of a cooling medium for the heat exchanger.

10. The process according to claim 9, further comprising providing a third regulation circuit for regulation of at least one of the cooling temperature and cooling rate of the cooling medium as a function of the time-delayed heat exchange performance.

11. A system for regulating a continuous crystallization process, especially for preparing bisphenol A, the system comprising:
a crystallization apparatus;
a heat exchanger connected in a circuit to the crystallization apparatus and adapted to cool an exit stream of the crystallization apparatus, wherein at least one of a crystallization temperature of the crystallization apparatus and an exit temperature of the exit stream is delivered by regulation using a heat exchange performance of the heat exchanger, the heat exchange performance being adjustable as a function of a feed stream supplied with the aid of an establishment unit; and
at least one calculator unit adapted to calculate the heat exchange performance, wherein the calculated heat exchange performance is passed on to the establishment unit, wherein the establishment unit establishes the calculated heat exchange performance in the heat exchanger with a time delay.

12. The system according to claim 11, further comprising:
a first regulation circuit adapted to deliver, with the time delay, a heat exchanger target exit temperature by regulation as a function of the exit temperature of the crystallization apparatus; and
a second regulation circuit adapted to deliver a correction term for the time delay of the heat exchanger target exit temperature by regulation as a function of the feed stream.

13. The system according to claim 12, wherein the first regulation circuit comprises a first regulator for delivery of the heat exchanger target exit temperature by regulation and a second regulator for delivery of at least one of a cooling temperature and a cooling rate of a cooling medium for the heat exchanger by regulation, the first regulator reacting more slowly than the second regulator.

14. The system according to claim 13, wherein at least one of the first regulator and the second regulator comprises a PID regulator.

15. The system according to claim 12, wherein the second regulation circuit comprises a third regulator comprising regulation parameters which are adjustable as a function of at least one of a fouling state of the heat exchanger and a heat transfer coefficient k of the heat exchanger.

16. The system according to claim 13, wherein at least one of the first regulator and the third regulator comprises a PT₁ regulator.

17. The system according to claim 11, further comprising a temperature measuring instrument adapted to measure a heat exchanger exit temperature, wherein the measured heat exchanger exit temperature is comparable with a heat exchanger exit temperature determined by calculation by the calculator unit with the aid of the calculator unit, in order to determine at least one of a fouling state of the heat exchanger and a heat transfer coefficient k of the heat exchanger.
